(19) United States
(12) Patent Application Publication
(10) Pub. No.: US 2026/0042687 A1
(43) Pub. Date: Feb. 12, 2026

(54) ELECTROLYSIS WATER FILTER SYSTEM

(71) Applicant: JOW TONG TECHNOLOGY CO., LTD., TAINAN CITY (TW)

(72) Inventor: CHUNG-HUNG LIN, TAINAN CITY (TW)

(21) Appl. No.: 18/796,644

(22) Filed: Aug. 7, 2024

(51) Int. Cl. C02F 1/461; C02F 1/00; C02F 1/467; C02F 1/68

(52) U.S. Cl. CPC C02F 1/4618; C02F 1/002; C02F 1/4676; C02F 1/68; C02F 2001/4619; C02F 2201/005; C02F 2201/007; C02F 2201/46145; C02F 2209/001; C02F 2209/006; C02F 2209/03

(57) ABSTRACT

An electrolysis water filter system is provided. A partial pressure ball valve and a water flow sensor are respectively used to control a pressure magnitude of a water flow passed through and detect a pressure magnitude of a water flow passed through. When the detected pressure of the water flow is larger than a preset value, a power of an electrolyser is controlled to be disconnected. When the detected pressure of the water flow is smaller than the preset value, the electrolyser is controlled to be activated and water passed through is electrolyzed to generate hydrogen-rich water. When the power of the electrolyser is off, clean water filtered by a filter module passes through the electrolyser to flow out through a water outlet directly. Thereby users can select either the hydrogen-rich water generated by electrolysis or the clean water generated by filtration of the filter module to use.

### BACKGROUND OF THE INVENTION

### Field of the Invention

The present invention relates to an electrolysis water filter system, especially to an electrolysis water filter system by which users can select either hydrogen-rich water generated by electrolysis or clean water generated only by filtration of a filter module to use. The water filter system is more convenient to use and consumers have more options.

### Description of Related Art

Hydrogen water (also called hydrogen-rich water) is a water containing a lot of hydrogen ions. Hydrogen molecules are quite small and able to reach nerve system, cells, and organs directly for enhancing metabolism, adjustment of the body, and maintenance of health. They are natural antioxidants so that drinking hydrogen-rich water has multiple functions including anti-oxidation, anti-inflammation, anti-apoptosis, and cell repairing.

Refer to Taiwanese Pat. Pub. No. M635882 “hydrogen-rich ozone water manufacturing equipment”, water is completely purified into clean RO (reverse osmosis) water by filter materials with different functions mounted in respective filter cartridges therein. Then the clean RO water is converted into alkaline water with an electric potential which is lower than that of hydrogen by a hydrogen-rich ozone water generating module inside the manufacturing equipment. Thereby hydrogen-rich ozone water with high permeability and solubility is further generated and output through a water outlet for allowing users to drink.

Although the above hydrogen-rich ozone water manufacturing equipment can achieve expected functions, it still has certain limits. While in use, family filter systems are usually disposed on the kitchen. Besides drinking directly, the filtered water is used in cooking meals. The water introduced into the hydrogen-rich ozone water manufacturing equipment through a water inlet is directly electrolyzed to generate hydrogen-rich water and users can't choose whether to electrolyze the water or not according to their needs. This is a kind of waste. Thus there is room for improvement and there is a need to provide a water filter system with novel design.

### SUMMARY OF THE INVENTION

Therefore, it is a primary object of the present invention to provide an electrolysis water filter system which allows users to select hydrogen-rich water generated by electrolysis or clean water generated only by filtration of a filter module to use. Thus the water filter system with a variety of uses is more convenient to use.

In order to achieve the above object, an electrolysis water filter system according to the present invention mainly includes a water purifier and a filter module.

The ware purifier consists of a water inlet connected with a partial pressure ball valve which is used for allowing users to control a pressure magnitude of a water flow passed through and connected to the filter module. The filter module is used for filtering a water flow passed through and connected to an electrolyser which is connected to a water outlet. A water flow sensor is connected with and disposed between the partial pressure ball valve and the filter module for detecting a pressure magnitude of a water flow. A processing unit is electrically connected to the water flow sensor and the electrolyser. The processing unit controls on or off of the electrolyser. The water flow sensor sends signals to the processing unit to disconnect a power of the electrolyser when the water flow sensor detects that the pressure of the water flow passed through is larger than a preset value. Thus clean water filtered by the filter module directly passes through the electrolyser and the water outlet to flow out. When the water flow sensor detects that the pressure of the water flow passed through is smaller than the preset value, the water flow sensor sends signals to the processing unit to activate the electrolyser. Thus a water flow passed through the electrolyser is electrolyzed to generate hydrogen-rich water which is flowing out through the water outlet to be used by users.

Preferably, the water flow sensor can also detect the amount of the water flow passed through. The processing unit is electrically connected to a storage unit and a warning unit. The storage unit is used to record and store the amount of water flow passed through being detected by the water flow sensor. When the amount of the water flow recorded in the storage unit has accumulated to a preset value, the warning unit sends warning signals under control of the processing unit.

Preferably, the warning unit is a light emitting diode.

Preferably, the filter module is composed of an upper housing and a lower housing assembled with each other, a first filter set, a second filter set, and a third filter set. The first filter set, the second filter set, and the third filter set are mounted in an assembly of the upper housing and the lower housing. The upper housing and the lower housing are respectively provided with an upper through hole and a lower through hole for connection with the electrolyser and the water inlet correspondingly.

Preferably, the first filter set, the second filter set, and the third filter set are all provided with filter materials which are active charcoal, ceramic beads, hollow fiber membrane, bamboo charcoal, far-infrared filter, or their combinations.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded view of an embodiment according to the present invention;

FIG. 2 is a schematic drawing showing architecture of an embodiment according to the present invention;

FIG. 3 is a perspective view of an embodiment according to the present invention;

FIG. 4 is an exploded view of a filter module of an embodiment according to the present invention;

FIG. 5 is a sectional view of an embodiment in use according to the present invention;

FIG. 6 is a flow chart showing steps of an embodiment in use according to the present invention.

### DETAILED DESCRIPTION OF THE PREFERRED EMBODIMENT

In order to learn technical content, features, and functions of the present invention more clearly and completely, please refer to the following embodiments with related figures and reference signs.

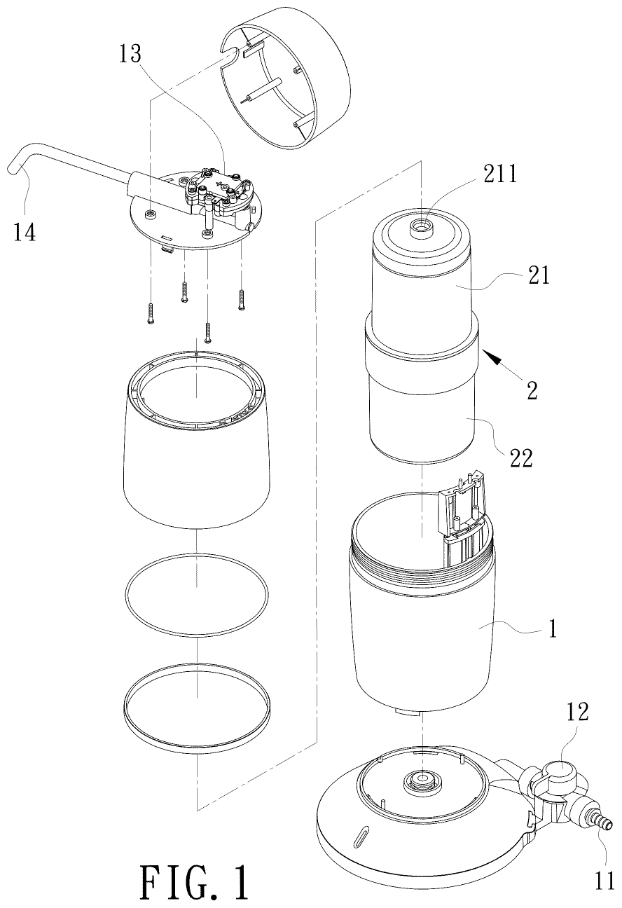

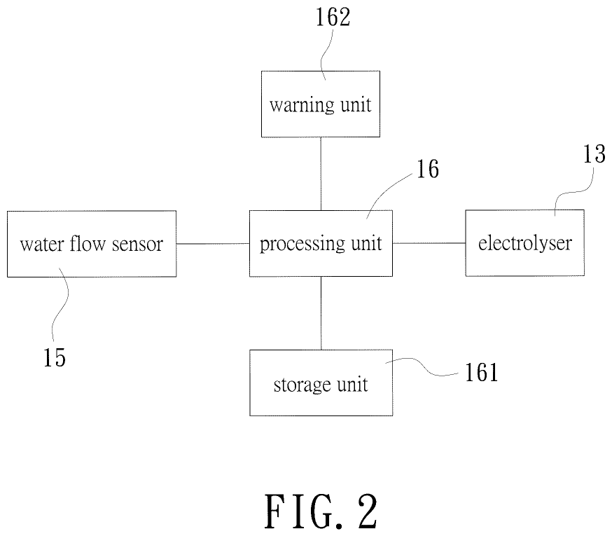

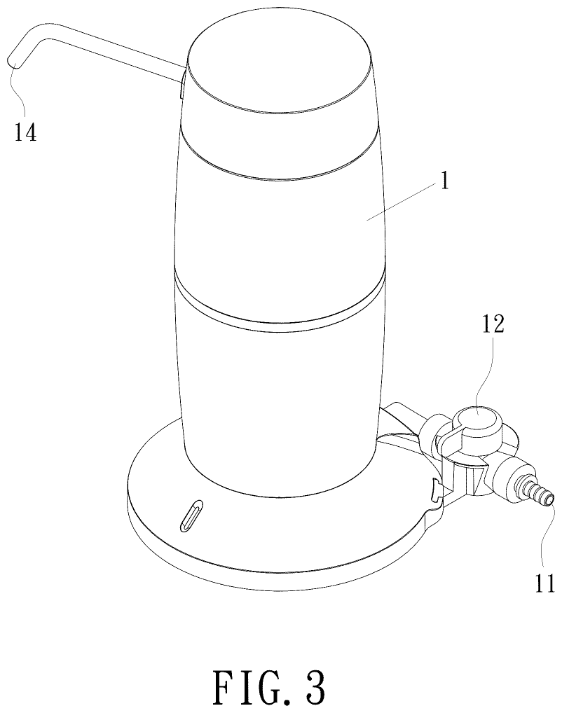

Refer to FIG. 1, FIG. 2, and FIG. 3, an electrolysis water filter system according to the present invention mainly includes a water purifier 1 and a filter module 2.

The water purifier 1 consists of a water inlet 11, a partial pressure ball valve 12 connected to the water inlet 11 and the filter module 2 and used for allowing users to control a pressure magnitude of a water flow passed through, an electrolyser 13 connected to the filter module 2, a water outlet 14 connected to the electrolyser 13, a water flow sensor 15 connected with and disposed between the partial pressure ball valve 12 and the filter module 2 and used for detecting the amount of a water flow passed through and a pressure magnitude of the water flow, and a processing unit 16 electrically connected to the water flow sensor 15. The filter module 2 is used for filtering a water flow passed through. The processing unit 16 is electrically connected to a storage unit 161 and a warning unit 162. The storage unit 161 is used to record and store the amount of a water flow passed through which is detected by the water flow sensor 15. When the amount of the water flow recorded in the storage unit 161 has accumulated to a preset value, the warning unit 162 sends warning signals under control of the processing unit 16. The warning unit 162 can be a light emitting diode. The processing unit 16 is also electrically connected to the electrolyser 13 to turn on or turn off the electrolyser 13. The water flow sensor 15 sends signals to the processing unit 16 to disconnect a power of the electrolyser 13 when the water flow sensor 15 detects that the pressure of the water flow passed through is larger than a preset value. Thus the electrolyser 13 is turned off under control of the processing unit 16 and clean water filtered by the filter module 2 directly passes through the electrolyser 13 and the water outlet 14 to flow out. When the water flow sensor 15 detects that the pressure of the water flow passed through is smaller than the preset value, the water flow sensor 15 sends signals to the processing unit 16 to turn on the electrolyser 13. Thus water passed through the electrolyser 13 is electrolyzed to generate hydrogen-rich water which flows out through the water outlet 14 to be used by users.

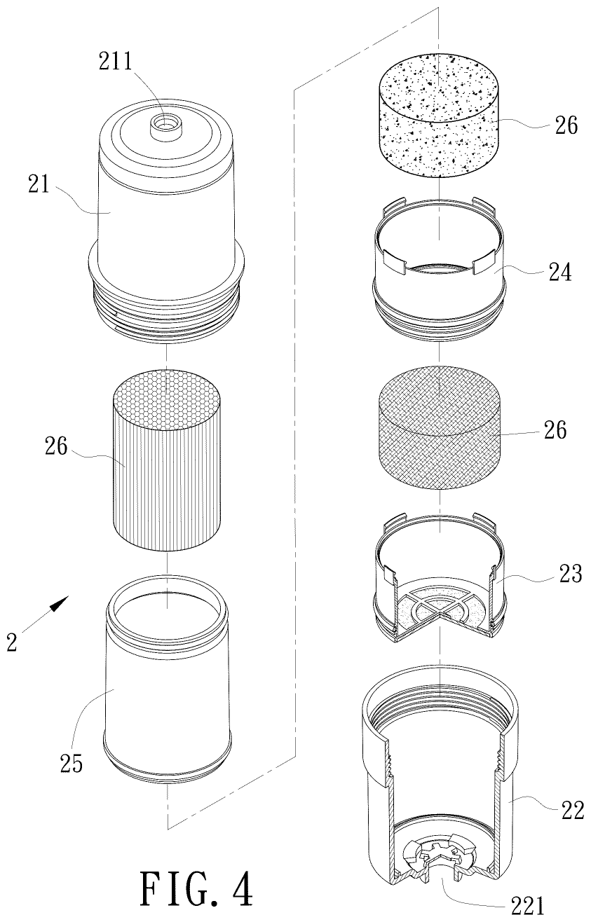

Also refer to FIG. 4, the filter module 2 is composed of an upper housing 21 and a lower housing 22 assembled with each other, a first filter set 23, a second filter set 24, and a third filter set 25, and filter materials 26. The first filter set 23, the second filter set 24, and the third filter set 25 are mounted in an assembly of the upper housing 21 with the lower housing 22. The upper housing 21 and the lower housing 22 are respectively provided with an upper through hole 211 and a lower through hole 221 for connection with the electrolyser 13 and the water inlet 11 correspondingly. The first filter set 23, the second filter set 24, and the third filter set 25 are mounted into the upper housing 21 and the lower housing 22 and provided with the filter materials 26 filled therein. The filter materials 26 filled into the first, the second, and the third filter sets 23, 24, 25 can be active charcoal, ceramic beads, hollow fiber membrane, bamboo charcoal, far-infrared filter, or their combinations.

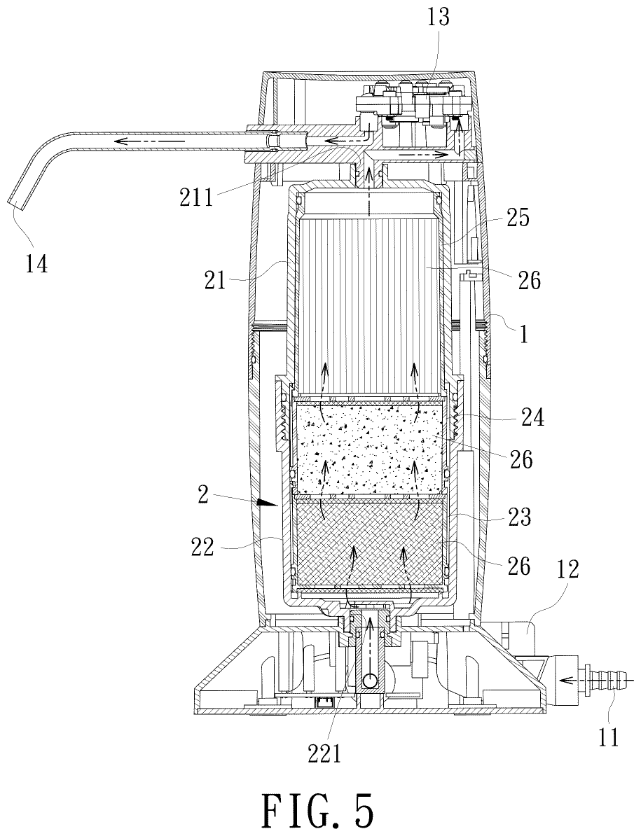

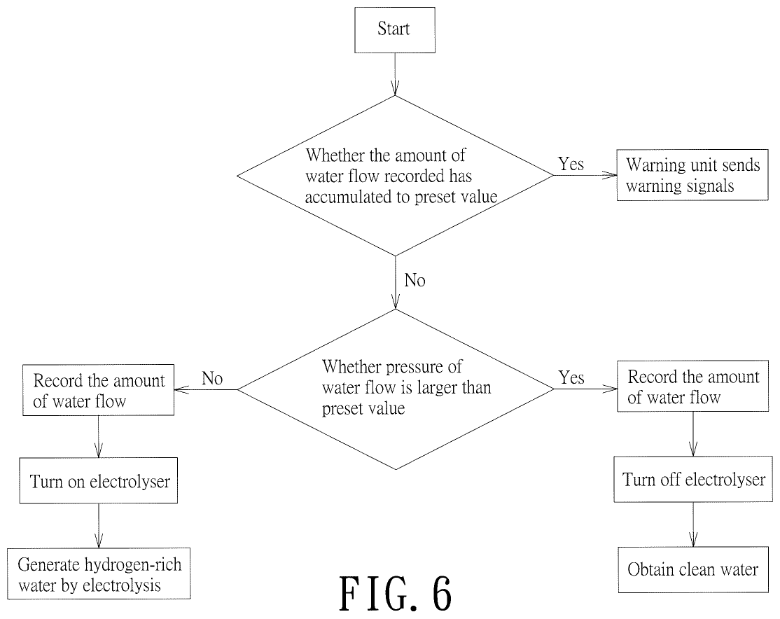

Refer to FIG. 5 and FIG. 6, while in use, the processing unit 16 continues to check whether the amount of the water flow passed through sensed by the water flow sensor 15 and recorded and stored in the storage unit 161 has accumulated to the preset value. When the amount of the water flow has reached the preset value, the processing unit 16 controls the warning unit 162 to give warning signals in order to inform the user to replace the filter module 2. When the user needs to use electrolyzed hydrogen-rich water, the partial pressure ball valve 12 is controlled to adjust the pressure of water flow passed through to be lower than the preset value. The amount of water flow passed through is sensed by the water flow sensor 15 and stored in the storage unit 161 after the water flow flowing into the system through the water inlet 11 and passed through the partial pressure ball valve 12. At the same time, the water flow sensor 15 sends signals to the processing unit 16 to activate the electrolyser 13 when the water flow sensor 15 detects that the pressure of the water flow passed through is smaller than the preset value. The water flow passes through the filter module 2 so that impurities, odors, etc. in the water flow are filtered by the filter materials 26 mounted in the first filter set 23, the second filter set 24, and the third filter set 25. Next the clean filtered water passes through the electrolyser 13 to be electrolyzed so that hydrogen-rich water generated by electrolysis flows out through the water outlet 14 to be used by the user. Moreover, when the user only needs to use clean filtered water, the partial pressure ball valve 12 is controlled to adjust the pressure of the water flow passed through to be higher than the preset value. The amount of water flow is sensed by the water flow sensor 15 and stored in the storage unit 161 after the water flow flowing into the system through the water inlet 11 and passed through the partial pressure ball valve 12. When the water flow sensor 15 detects the pressure of the water flow passed through is larger than the preset value, the water flow sensor 15 sends signals to the processing unit 16 to disconnect the power of the electrolyser 13. Thus the water flow passed through the filter module 2 is filtered therein and then the clean filtered water is directly flowing through the electrolzyer 13 and going out through the water outlet 14 to be used by the user.

In summary, compared with techniques available now, the present invention has the following advantages.
1. By two-stage positioning control of the water valve, consumers can select to drink the hydrogen-rich water generated by electrolysis directly and timely, or only use clean filtered water output to cook foods, without use of the electrolyser and waste of energy.
2. The replacement of the filter module is easy and convenient. Manufacturers and suppliers can fill new filter materials and reuse the upper and the lower housings to avoid waste of resources.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An electrolysis water filter system comprising a water purifier and a filter module;
wherein the water purifier includes a water inlet, a partial pressure ball valve connected to the water inlet and the filter module and used for allowing users to control a pressure magnitude of a water flow passed through, an electrolyser connected to the filter module, a water outlet connected to the electrolyser, a water flow sensor connected with and disposed between the partial pressure ball valve and the filter module and used for detecting a pressure magnitude of the water flow, and a processing unit electrically connected to the water flow sensor and the electrolyser and used to turn on or off the electrolyser; the filter module is used for filtering the water flow passed through; wherein the water flow sensor sends signals to the processing unit to disconnect a power of the electrolyser when the water flow sensor detects that the pressure of the water flow passed through is larger than a preset value; thus clean water filtered by the filter module directly passes through the electrolyser and the water outlet to flow out; wherein the water flow sensor sends signals to the processing unit to turn on the electrolyser when the water flow sensor detects that the pressure of the water flow passed through is smaller than the preset value; thereby water passed through the electrolyser is electrolyzed to generate hydrogen-rich water which flows out through the water outlet to be used by users.

2. The electrolysis water filter system as claimed in claim 1, wherein the water flow sensor also detects the amount of the water flow passed through at the same time; the processing unit is electrically connected to a storage unit and a warning unit; the storage unit is used to record and store the amount of the water flow passed through being detected by the water flow sensor; when the amount of the water flow recorded in the storage unit has accumulated to a preset value, the warning unit sends warning signals under control of the processing unit.

3. The electrolysis water filter system as claimed in claim 2, wherein the warning unit is a light emitting diode.

4. The electrolysis water filter system as claimed in claim 1, wherein the filter module includes an upper housing and a lower housing assembled with each other, a first filter set, a second filter set, and a third filter set; the first filter set, the second filter set, and the third filter set are mounted in the upper housing and the lower housing assembled with each other; the upper housing and the lower housing are respectively provided with an upper through hole and a lower through hole for connection with the electrolyser and the water inlet correspondingly.

5. The electrolysis water filter system as claimed in claim 4, wherein the first filter set, the second filter set, and the third filter set are provided with a filter material which is selected from the group consisting of active charcoal, ceramic beads, hollow fiber membrane, bamboo charcoal, far-infrared filter, and a combination thereof.
